(19) United States
(12) Patent Application Publication
(10) Pub. No.: US 2009/0140794 A1
(43) Pub. Date: Jun. 4, 2009

(54) CONSTANT-CURRENT CHARGE PUMP

(76) Inventor: Chi-Hao Wu, Taipei City (TW)

Correspondence Address: Joe McKinney Muncy, PO Box 1364, Fairfax, VA, 22038-1364, US

(21) Appl. No.: 11/947,348

(22) Filed: Nov. 29, 2007

(51) Int. Cl. G05F 1/575

(52) U.S. Cl. 327/536

(57) ABSTRACT

The present invention discloses a constant-current charge pump, wherein a current detection circuit and a regulation circuit are arranged in the output of a pump circuit and used to control the current output by the pump circuit. When the load varies, the current variation is detected, and the regulation circuit pumps and regulates the current output by the pump circuit to stabilize the output current. Thereby, the output current will vary very slightly for different loads and input voltages.

### FIELD OF THE INVENTION

The present invention relates to a charge pump, particularly to a charge pump applying to an LED driver circuit.

### BACKGROUND OF THE INVENTION

Recently, LCD (Liquid Crystal Display) of mobile phones, PDA (Personal Digital Assistant), etc., has evolved from a monochromatic display to a colored one. As liquid crystal itself cannot emit light, LCD needs a backlight unit. Due to the consideration of power consumption, white-light LEDs have replaced traditional electric bulbs to function as the light source of a backlight unit. A white-light LED needs a high forward voltage and a high forward current. The current control of a backlight unit has a dominating influence on the running time of the batteries of a portable electronic device. A charge pump is usually used in a backlight unit to achieve high energy efficiency and is often designed to be a 1.5× power supply or a 2× one.

With using a common white-light LED driver IC, a white-light LED usually receives an input voltage of only 2.6-3.5V. However, a white-light LED needs to be driven by a current of 20 mA. Therefore, a white-light LED needs a forward voltage of about 3.6-4.0V, which is higher than the input voltage. Thus, a charge pump is used to raise the input voltage.

Refer to FIG. 1 a diagram schematically showing the architecture of a conventional charge pump circuit. An external pump capacitor Cp is coupled to a conventional 2× charge pump circuit 10, and the output of the charge pump 10 is coupled to an output capacitor Co, which is grounded. The 2× charge pump circuit 10 is simply to double the input voltage. Therefore, a current regulator 30 is added to behind the load 20 (white-light LED) to obtain a stable 20 mA current.

Refer to FIG. 2 a diagram schematically showing the circuit of a conventional charge pump circuit. The conventional charge pump circuit 10 has a charge transistor 11 and a discharge transistor 12. Two external pads P_{C1} and P_{C2} are respectively coupled to two sides of a pump capacitor Cp; the output terminal of the charge pump circuit 10 is coupled to a load 20 via a pad P_{OUT}; the charge pump circuit 10 is grounded via a pad P_{GND}. If the charge pump IC is incorporated with a current regulator 30, the IC needs additional pins to connect with the load 20 so that the load 20 can connect with the current regulator 30. As light-white LEDs need a great current, a plurality of pads P_{LED} is used to supply power in parallel. In FIG. 2, ten pieces of pads P_{LED} are used. However, increasing the number of pads increases IC area. Further, it is hard to layout many pads.

### SUMMARY OF THE INVENTION

The objective of the present invention is to eliminate the current regulator, which is originally added behind the load in the application of a charge pump, and simplify the design of pins, wherein a detection circuit and a regulation circuit are added to between the output of a pump circuit and the load (white-light LED) to form a constant-current charge pump, which bumps current to achieve a stable output current according to the detected variation of the output current. Thereby, the output current will vary very slightly for different input voltages and loads.

The present invention proposes a constant-current charge pump, which comprises: a pump circuit used to boost voltage; an inverter used to control an external pump capacitor coupled to the pump circuit; a current detection circuit arranged in the output of the pump circuit and used to detect output current and convert current into voltage; and a regulation circuit receiving an input voltage and the voltage output by the current detection circuit and functioning as a negative feedback mechanism to regulate the current output by the pump circuit.

The current detection circuit further comprises: a resistor coupled to the output of the pump circuit and used to detect an output current; and a voltage amplifier receiving voltage difference between two ends of the resistor, amplifying the voltage difference and transmitting the voltage difference amplified to the regulation circuit.

The regulation circuit further comprises: an error amplifier receiving a voltage sent out by the current detection circuit and comparing the voltage with a reference voltage; and a regulation transistor receiving an input voltage and controlled by the error amplifier to regulate a current output by the pump circuit.

The regulation circuit is coupled to the inverter and providing a boost voltage required by the pump capacitor via the inverter. Alternatively, the regulation circuit is coupled to the input of the pump circuit and determines how much current the regulation transistor should pump to a charge transistor of the pump circuit.

In the present invention, a current detection circuit and a regulation circuit are arranged in the output of a pump circuit and used to control the current output by the pump circuit. When the load varies, the circuit changes the current amount of the pump circuit to regulate the output current. The design of the present invention doesn't need to add a current regulator to behind the load. Further, in the present invention, the output current will vary very slightly (about below 0.5%) for different loads and input voltages. The performance of the constant-current charge pump of the present invention is satisfactory and very close to that of a charge pump with an external current regulator.

### BRIEF DESCRIPTION OF THE DRAWINGS

FIG. 1 is a diagram schematically showing the architecture of a conventional charge pump circuit and additional current regulator.

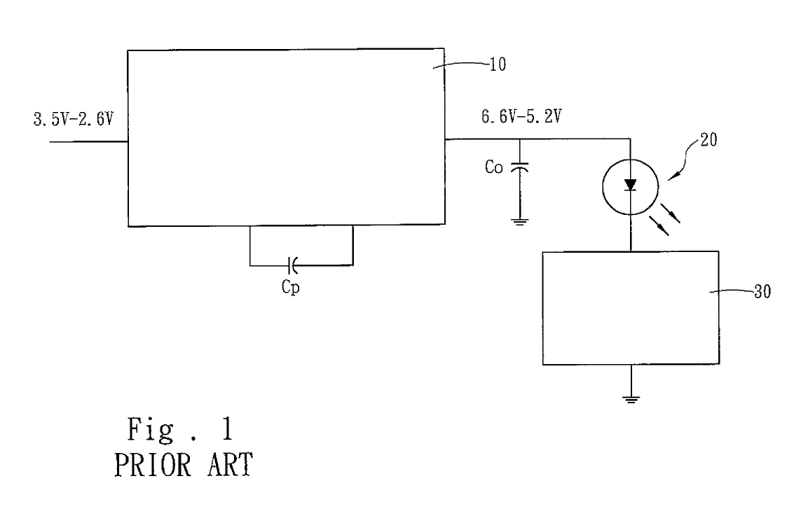

FIG. 2 is a diagram schematically showing the circuit of a conventional charge pump circuit and additional current regulator.

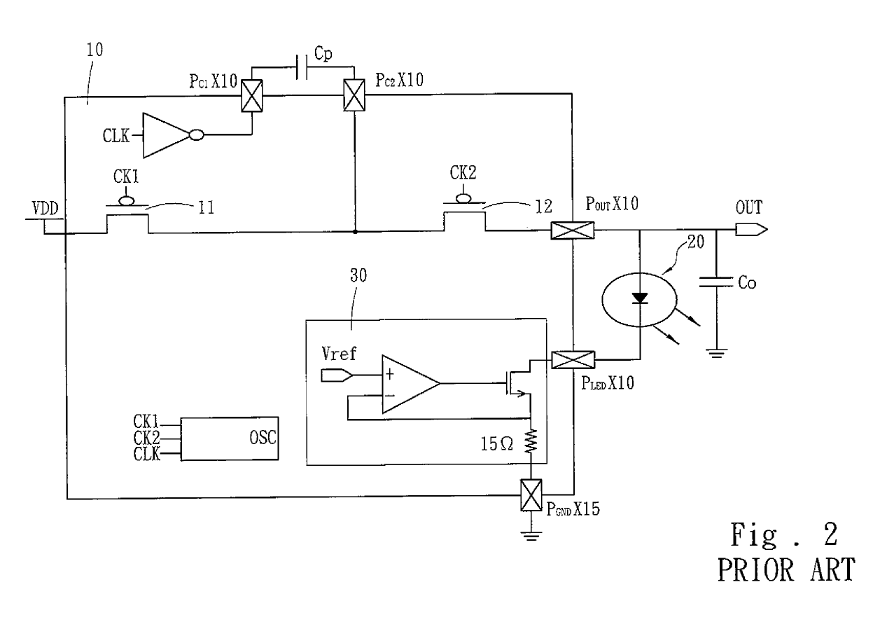

FIG. 3 is a diagram schematically showing the architecture of a constant-current charge pump according to the present invention.

FIG. 4 is a diagram schematically showing the circuit of a constant-current charge pump according to the present invention.

FIG. 5 is a diagram showing the detailed circuit of FIG. 4.

FIG. 6 is a diagram showing the detailed circuit of another embodiment of a constant-current charge pump according to the present invention.

### DETAILED DESCRIPTION OF THE PREFERRED EMBODIMENTS

Below, the technical contents of the present invention are to be described in detail with the embodiments. However, it should be understood that the embodiments are only to exemplify the present invention but not to limit the scope of the present invention.

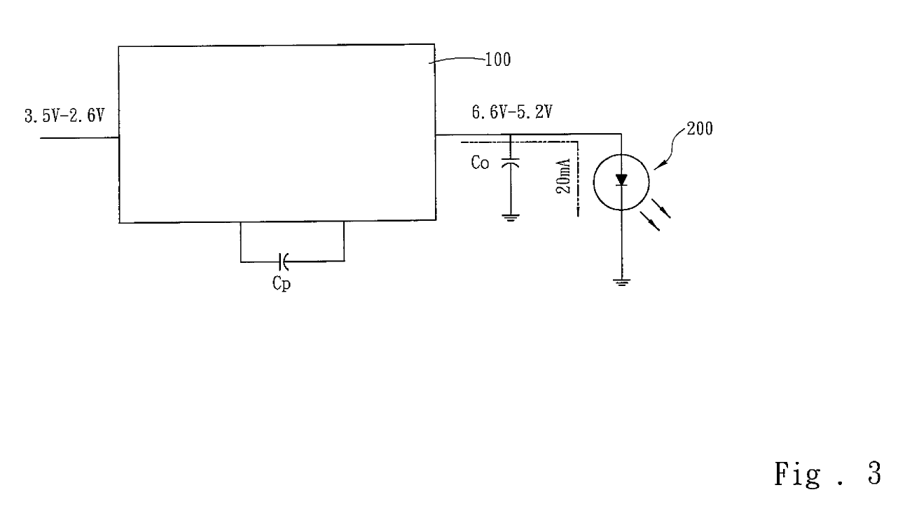

Refer to FIG. 3 a diagram schematically showing the architecture of a constant-current charge pump according to the present invention, wherein a 2× charge pump is used to exemplify the present invention. Similar to a common charge pump, the constant-current charge pump 100 of the present invention is coupled to an external pump capacitor Cp, and the output of the charge pump 100 is coupled to an output capacitor Co, which is grounded. The constant-current charge pump 100 is to double the input voltage and provide a constant current 200 mA for a load 200 (white-light LED).

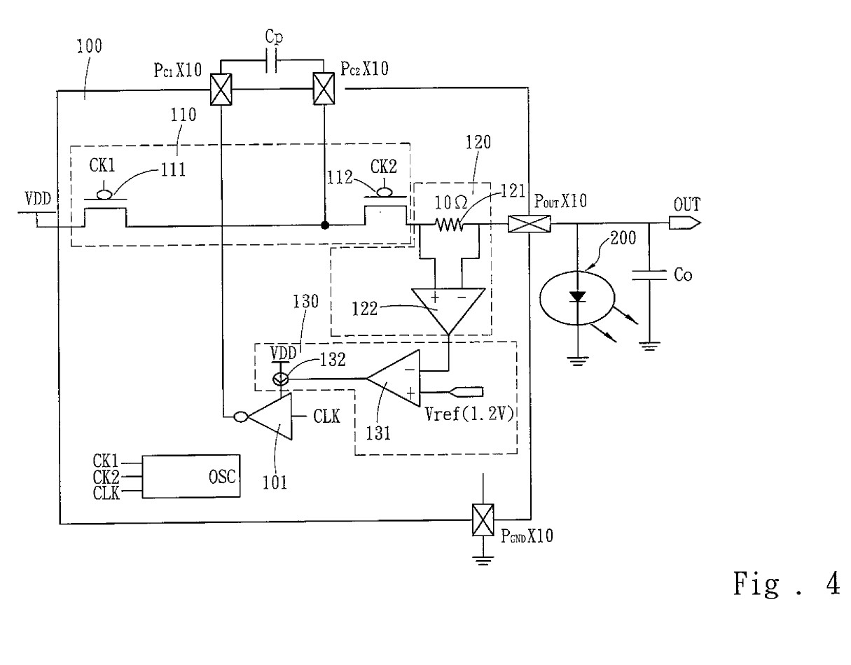

Refer to FIG. 4 a diagram schematically showing the circuit of a constant-current charge pump according to the present invention. The constant-current charge pump 100 comprises a pump circuit 110, and the pump circuit 110 includes a charge transistor 111 and a discharge transistor 112 sequentially arranged in between the input voltage VDD and the output OUT. One side of the external pump capacitor Cp is coupled to between the charge transistor 111 and the discharge transistor 112; the other side of the external pump capacitor Cp is coupled to the output of an inverter 10 1. The output OUT of the constant-current charge pump 100 is coupled to a grounded output capacitor Co and a load 200 (such as a white-light LED).

In the present invention, a current detection circuit 120 and a regulation circuit 130 are arranged in before the output OUT to control the output current of the constant-current charge pump 100. The current detection circuit 120 detects the variation of the output current. The regulation circuit 130 utilizes a negative feedback mechanism and an appropriate current-regulating mechanism to pump a voltage and regulate an output current for achieving fast load response and current stabilization. When the load 200 varies, the current output by the charge pump 100 is regulated to achieve a stable current.

The current detection circuit 120 includes a resistor 121 and a voltage amplifier 122. The resistor 121 is arranged in between the pump circuit 110 and the output OUT and used to detect the output current. The voltage amplifier 122 is coupled to two ends of the resistor 121 and transfers the voltage difference between two ends of the resistor 121 to the regulation circuit 130. The regulation circuit 130 includes an error amplifier 131 and a regulation transistor 132. The error amplifier 131 receives the voltage output by the voltage amplifier 122 and functions as a negative feedback mechanism to regulate output current. The positive input terminal of the error amplifier 131 receives a reference voltage Vref (such as 1.2V), and the negative input terminal of the error amplifier 131 receives the voltage transformed from the output current. The error amplifier 131 determines how much current the regulation transistor 132 will pump to the pump capacitor Cp via the inverter 101.

When the current required by the load 200 increases, the feedback voltage received by the error amplifier 131 also increases. Once the error amplifier 131 receives the error voltage, it will controls the regulation transistor 132 to release less current and stabilize the feedback voltage at the reference voltage Vref (such as 1.2V). The output current is a multiple of the product of the feedback voltage, the resistance of the resistor 121 (10Ω) and the magnification (6×) of the voltage amplifier 122; therefore, the output current will be stabilized at 20 mA(1.2V/6=0.2V and 0.2V/10Ω=20 mA).

The constant-current charge pump 100 of the present invention can provide a constant current for the load 200 and regulate output current without using any current regulator added to behind the pump circuit 110 or the load 200. Therefore, the present invention can simplify the design of IC pins and reduce numbers of pins.

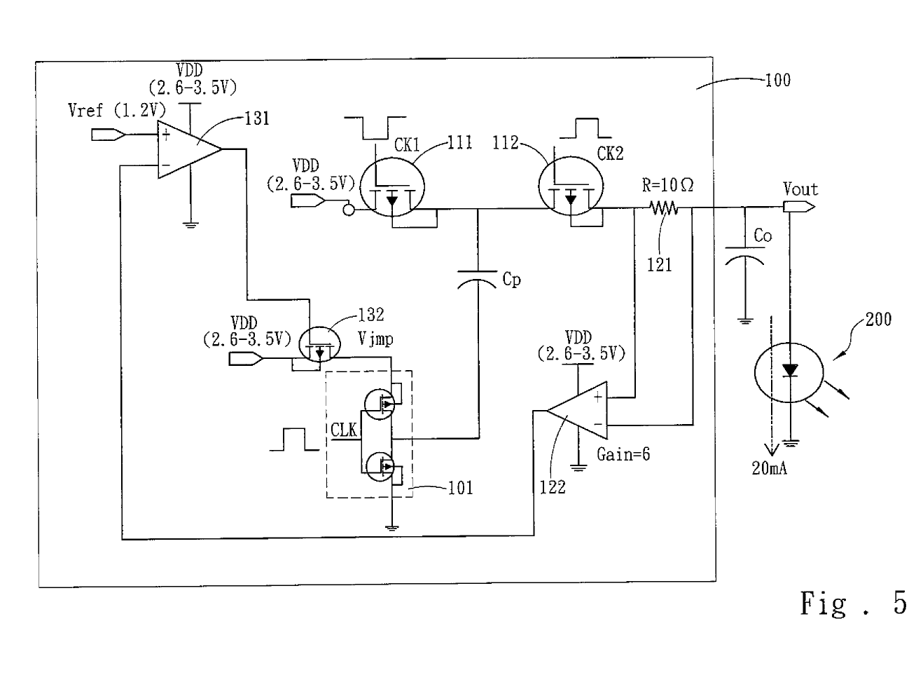

Refer to FIG. 5 a diagram showing the detailed circuit of FIG. 4. Suppose the constant-current charge pump 100 is a 2× pump circuit. The charge transistor 111 and the discharge transistor 112 of the pump circuit 110 are respectively controlled by a first clock CK1 and a second clock CK2, wherein the first clock CK1 and the second clock CK2 are out of phase. The inverter 101 includes a p-type transistor and an n-type transistor, and a third clock CLK of the inverter 101 is synchronous with the second clock CK2. The input terminal receives an input voltage (generally about 2.6-3.5V). The pump capacitor Cp is arranged in between the output of the inverter 101 and the junction of the charge transistor 111 and the discharge transistor 112.

When the load 200 needs a greater current, the voltage difference between two ends of the resistor 121 also increases. The voltage amplifier 122 converts the voltage difference into an error voltage and sends the error voltage to the error amplifier 131. Once the error amplifier 131 detects the error voltage, it will control the regulation transistor 132 to release less current and stabilize the feedback voltage at the reference voltage Vref (such as 1.2V). Then, the error amplifier 131 can determine how much current the regulation transistor 132 should pump to make the inverter 101 able to provide a boost voltage Vjmp for the pump capacitor Cp. Thus, the output voltage Vout of the constant-current charge pump 100 is the sum of the boost voltage Vjmp and the input voltage VDD received by the charge transistor 111 of the pump circuit 110.

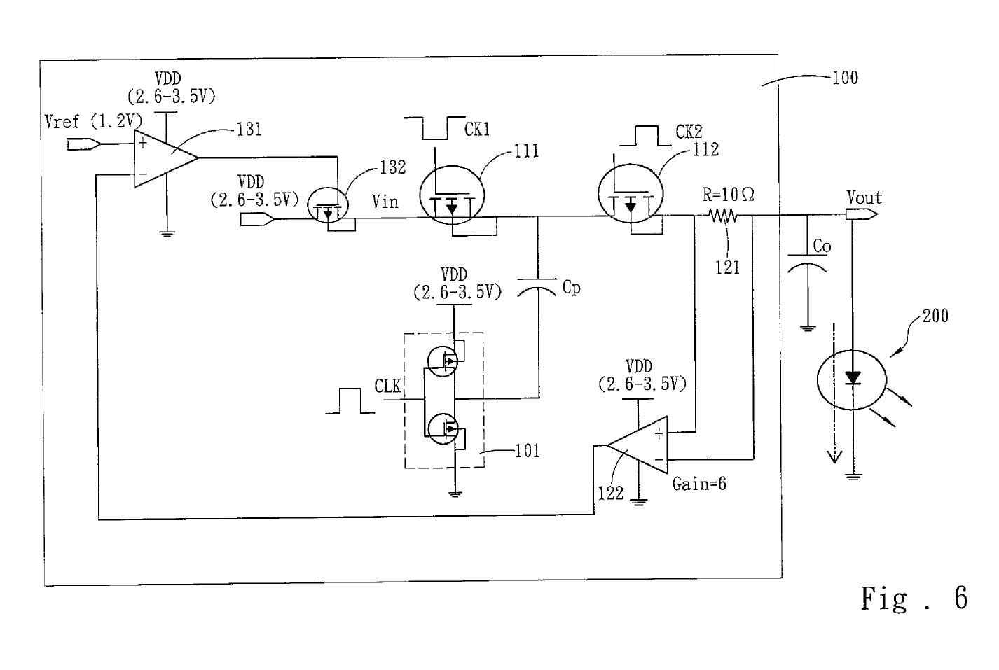

Refer to FIG. 6 a diagram showing the detailed circuit of another embodiment of a constant-current charge pump according to the present invention. FIG. 6 is different from FIG. 4 and FIG. 5 in that the regulation transistor 132 of the regulation circuit 130 is arranged in before the charge transistor 111 of the pump circuit 110. When the load 200 needs a greater current, the voltage difference between two ends of the resistor 121 also increases. The voltage amplifier 122 converts the voltage difference into an error voltage and sends the error voltage to the error amplifier 131. Once the error amplifier 131 detects the error voltage, it will control the regulation transistor 132 to release less current and stabilize the feedback voltage at the reference voltage Vref (such as 1.2V). Then, the error amplifier 131 can determine how much current the regulation transistor 132 should pump so that the charge transistor 111 of the pump circuit 110 can obtain the required input voltage Vin. Thus, the output voltage Vout of the constant-current charge pump 100 is the sum of the input voltage Vin and the source voltage VDD received by the inverter 101.

The spirit of the present invention is to obtain a stable current seemingly generated by a current regulator without using any current regulator, which will increase the numbers of pins and pads. In the present invention, a control circuit (the current detection circuit 120 and regulation circuit 130) is added to between the pump circuit 110 and the load 200. The control circuit functions like a water pipe. When the control circuit detects the variation of the load resistance or the input voltage, the water pipe of the control circuit varies its diameter to stabilize the current. Thus, the output current is not decided by the load resistance or the input voltage but by the control circuit. Thereby, a stable current, which does not vary with the load or the input voltage, is achieved.

Those described above are only the preferred embodiments to exemplify the present invention but not to limit the scope of the present invention. Any equivalent modification or variation according to the spirit of the present invention is to be also included within the scope of the present invention.

1. A constant-current charge pump comprising:
a pump circuit used to boost voltage;
an inverter used to control an external pump capacitor coupled to said pump circuit;
a current detection circuit arranged in an output of said pump circuit and used to detect an output current and transform said output current into voltage;
wherein said current detection circuit further comprises:
a resistor arranged in between the output and said pump circuit and used to detect an output current; and
a voltage amplifier receiving voltage difference between two ends of said resistor, amplifying said voltage difference and transmitting said voltage difference amplified to said regulation circuit; and
a regulation circuit, coupled to said inverter, receiving an input voltage and a voltage sent out by said current detection circuit, providing a boost voltage required by said pump capacitor via said inverter, and functioning as a negative feedback mechanism to regulate a current output by said pump circuit.

2. (canceled)

3. The constant-current charge pump according to claim 1, wherein said regulation circuit further comprises:
an error amplifier receiving a voltage sent out by said current detection circuit and comparing said voltage with a reference voltage; and
a regulation transistor receiving an input voltage and controlled by said error amplifier to regulate a current output by said pump circuit.

4. (canceled)

5. The constant-current charge pump according to claim 1, wherein said regulation circuit is coupled to an input of said pump circuit and determines how much current a regulation transistor should pump to a charge transistor of said pump circuit.
